(19) United States
(12) Patent Application Publication
(10) Pub. No.: US 2025/0061214 A1
(43) Pub. Date: Feb. 20, 2025

(54) INTELLIGENT TRACING OF SENSITIVE DATA FLOW AND PRIVACY

(71) Applicant: Traceable Inc., San Francisco, CA (US)

(72) Inventors: Sudeep Padiyar, Sunnyvale, CA (US); Amod Gupta, San Francisco, CA (US); Sanjay Nagaraj, Dublin, CA (US); Ravindra Guntur, Hyderabad (IN); Roshan Piyush, Bengaluru (IN); Satish Mittal, Bengaluru (IN); Anuj Goyal, Andhra Pradesh (IN)

(73) Assignee: Traceable Inc., San Francisco, CA (US)

(21) Appl. No.: 18/235,846

(22) Filed: Aug. 19, 2023

(51) Int. Cl. G06F 21/62

(52) U.S. Cl. CPC G06F 21/62

(57) ABSTRACT

A system that intelligently traces and identify sensitive data, tracks the flow of the sensitive data and is able to quickly and accurately identify privacy compliance issues. Tracing agents installed in a monitored system intercept API requests and responses, store the data, and process the data. Processing the data may include grouping APIs based on type and identifying user sessions. Baseline activity of a valid user is determined based on the analyze request and response data, and blocking rules can be applied at each individual tracing agent. The blocking rules can prevent unauthorized transmission of sensitive data, privacy violations, unauthorized users, and other improper access to data. The blocking rules may block all or a portion of an API request or response.

### BACKGROUND

The evolving API economy and micro-service architecture has resulted in a rapid pace of application development, elastic scaling and easy maintenance. However, it has also resulted in new data compliance and government challenges due to out-of-control trust boundaries and the inability to understand what happens to data in transit. Privacy audit and compliance teams neither have visibility into the nature of data in transit nor can they enforce compliance requirements on just-in-time computation. The situation has become worse due to the use of third-party API driven services resulting in unregulated trust boundaries across which data flows. Because data privacy is dealt with differently within different trust boundaries, the onus of ensuring privacy compliance is now confined to within these boundaries.

The issue with creating privacy models as is done presently by most systems is that it is a laborious manual process that is only viable in the rare situation when the application is static. What is needed is an improved way of enforcing privacy and protecting sensitive data.

### SUMMARY

The present technology intelligently traces and identifies sensitive data, tracks the flow of the sensitive data, and is able to quickly and accurately identify privacy compliance issues. The present system installs agents throughout a micro service system. The tracing agents intercept API requests and response data, store the data, and process the data. Processing the data may include grouping APIs based on type and identifying user sessions. Baseline activity of a valid user is determined based on analyzing API request and response data, and blocking rules can be applied at each individual tracing agent. The blocking rules can prevent unauthorized transmission of user sensitive data, privacy violations, unauthorized users, and other improper access to data. The blocking rules may block all or a portion of an API request or response.

A user model may be generated from the API request and response data, and may identify a user's typical API access points, geographical location, sensitive information requests, and other user data. The user data may be used to generate a user data report to a user or other authorized requesting entity, determine a user account breach, and determine data noncompliance by an API. The present system may also be used to detect data exfiltration using improper access to a user account.

In some instances, the present technology performs a method for tracing sensitive data flow. The method intercepts API traffic between a client and a plurality of microservices, and the API traffic including API requests and API responses associated with at least one user. API traffic is identified that contains user data identified as sensitive user data at one of the plurality of microservices. A blocking rule is applied at the one of the plurality of microservices. The blocking rule is applied to the API traffic that contains user data identified as sensitive user data. A response is then modified to remove, based on the blocking rule, the identified sensitive user data from being included within the response to the identified API traffic. The modified response is then transmitted.

In some instances, the present technology includes a non-transitory computer readable storage medium having embodied thereon a program, the program being executable by a processor to perform a method for tracing sensitive data flow. The method intercepts API traffic between a client and a plurality of microservices, and the API traffic including API requests and API responses associated with at least one user. API traffic is identified that contains user data identified as sensitive user data at one of the plurality of microservices. A blocking rule is applied at the one of the plurality of microservices. The blocking rule is applied to the API traffic that contains user data identified as sensitive user data. A response is then modified to remove, based on the blocking rule, the identified sensitive user data from being included within the response to the identified API traffic. The modified response is then transmitted.

In some instances, the present technology includes a system having one or more servers, each include memory and a processor. One or more modules are stored in the memory and executed by one or more of the processors to intercept API traffic between a client and a plurality of microservices, the API traffic including API requests and API responses associated with at least one user, identify API traffic that contains user data identified as sensitive user data at one of the plurality of microservices, apply a blocking rule, at the one of the plurality of microservices, to the API traffic that contains user data identified as sensitive user data, modify a response to remove, based on the blocking rule, the identified sensitive user data from being included within the response to the identified API traffic, and transmitting the modified response.

### BRIEF DESCRIPTION OF FIGURES

FIG. 1 is a block diagram of a system for intelligently tracing sensitive data flow and privacy.

FIG. 2 is a block diagram of a tracing agent.

FIG. 3 is a block diagram of an application.

FIG. 4 is a method for intelligently tracing sensitive data flow.

FIG. 5 is a method for grouping APIs based on data type.

FIG. 6 is a method for applying blocking rules at an agent.

FIG. 7 is a method for accessing an API data request and/or response.

FIG. 8 is a method for detecting a breach by an API.

FIG. 9 is a method for reporting user data to a user upon request.

FIG. 10 is a method for determining noncompliance by an API.

FIG. 11 is a method for detecting data exfiltration using a user account based on a user model.

FIG. 12 is a method for generating a risk score.

FIG. 13 is a block diagram of a computing environment for implementing the present technology.

### DETAILED DESCRIPTION

The present technology intelligently traces and identifies sensitive data, tracks the flow of the sensitive data, and is able to quickly and accurately identify privacy compliance issues. The present system installs agents throughout a micro service system. The tracing agents intercept API requests and response data, store the data, and process the data. Processing the data may include grouping APIs based on type and identifying user sessions. Baseline activity of a valid user is determined based on analyzing API request and response data, and blocking rules can be applied at each individual tracing agent. The blocking rules can prevent unauthorized transmission of user sensitive data, privacy violations, unauthorized users, and other improper access to data. The blocking rules may block all or a portion of an API request or response.

A user model may be generated from the API request and response data, and may identify a user's typical API access points, geographical location, sensitive information requests, and other user data. The user data may be used to generate a user data report to a user or other authorized requesting entity, determine a user account breach, and determine data noncompliance by an API. The present system may also be used to detect data exfiltration using improper access to a user account.

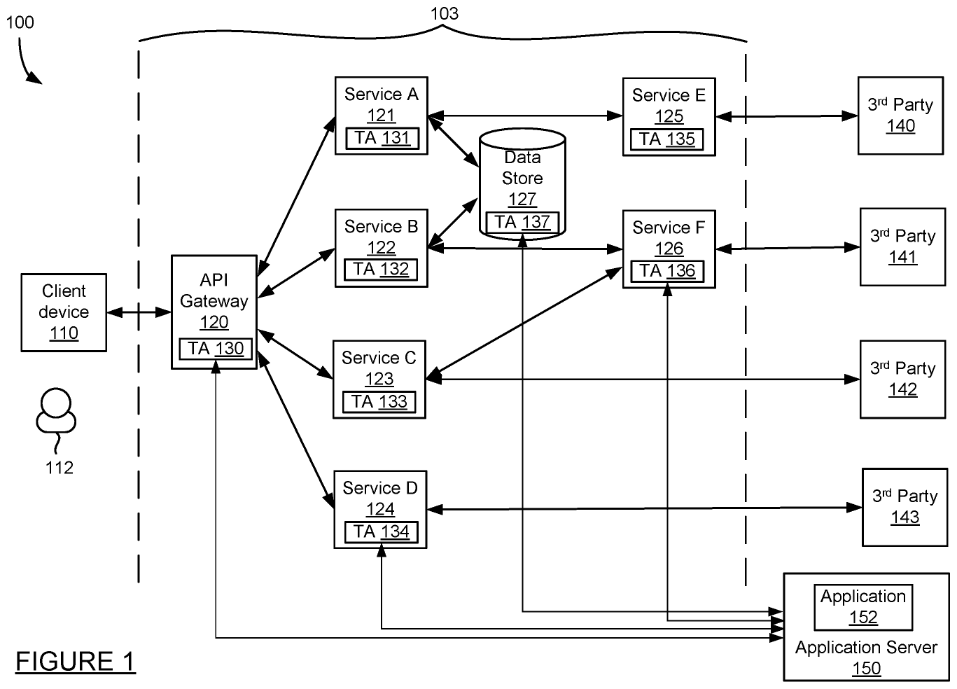

FIG. 1 is a block diagram of a system for intelligently tracing sensitive data flow and privacy. System 100 of FIG. 1 includes client device 110, API gateway 120, micro-service A 121, micro-service B 122, micro-service C 123, micro-service D124, micro-service E 125, micro-service F 126, data store 127, third-party server 140, third-party server 141, third-party server 142, third-party server 143, and application server 150.

API gateway 120, micro-service servers 121-126, and data store 127 may comprise a network-based service 103 provided to external clients such as client device 110. The network-based service 110 may include a plurality of micro-services to process requests, and may also communicate with third party servers 140-143. The network service 110 may be implemented in one or more cloud-based service providers, such as for example AWS by Amazon Inc, AZURE by Microsoft, GCP by Google, Inc., or some other cloud based service provider.

Each microservice may be implemented as a collection of software that implements a particular function or service. A microservice can be implemented in, for example, a virtual machine or a container, and as one or more processes. The microservices can be implemented on a separate server, or some microservices can be implemented on the same server. A microservice may include one or more APIs to which requests may be sent and from which responses may be transmitted. Each of micro-services 121-126 may implement a particular task or function, such as an e-commerce order service, reservation service, delivery service, menu service, payment service, notification service, or some other service that may be implemented over network.

In operation, a user 112 may initiate a request through client device 110 to network service 103. API gateway 120 receives the API request, and process the request by calling on one of micro-services 121, 122, 123 or 124 to process the request. The receiving micro-service may receive the request, process it, and provide a response, or contact another micro-service or third-party to further process the request. For example, API gateway 120 may receive a client API request, submit an API request a micro service C 123, which may then send an API request a micro service F 126. Micro-service F may then send a request to third-party 141. Third-party server 141 may process the request, and then send a result via an API response to micro-service F 126. Micro-service F 126 may receive the response, prepare a response to the request it originally received, and send its API response to micro-service E, which would then prepare and send an API response to API gateway 120. The API gateway may then generate its response to the user request, and send the prepared response to client device 110.

The network service 103 includes one or more tracing agent at each of the micro-services, data stores, and any other machine, VM, Container, or other processing software unit that receives an API request, processes a response, or as part of the transaction involving an API. As shown, tracing agent 130 is installed in API gateway 120, and tracing agents 131, 132, 133, 134, 135, 136, and 137 are installed in micro-services 121-126 and data store 127, respectively.

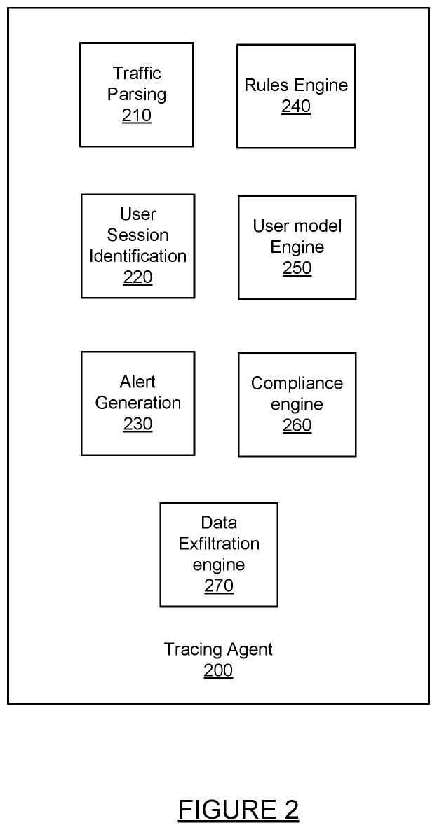

As API requests are received and API responses are sent by each micro-service service, data store, or other machine or node within network service 103, the tracing agent installed at that machine or node may intercept each API request and response, collect data from the intercepted traffic (i.e., intercepted API requests and responses), and process the collected data. Each tracing agent may also apply blocking rules to any data sent by the machine it is installed on, and report data to application server 150. In some instances, each microservice may include one or more APIs, and each microservice may include one or more tracing agents. Tracing agents are discussed in more detail with respect to the block diagram of FIG. 2.

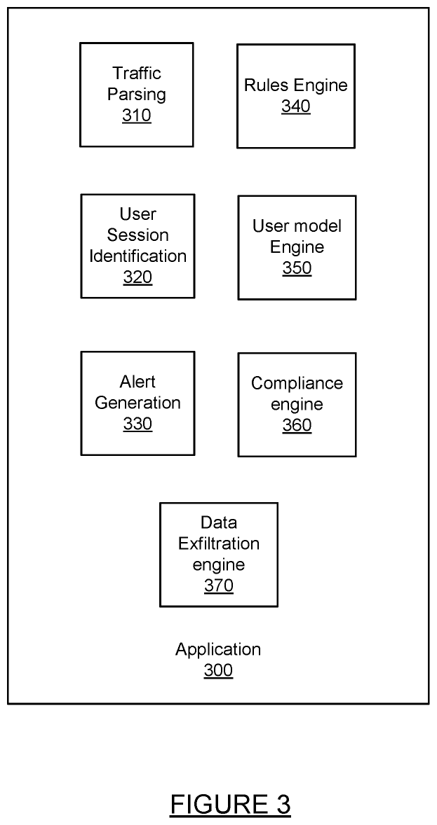

Application server 150 may receive data from each and every tracing agent in FIG. 1 (not all lines of communication between microservices and application 152 are illustrated in FIG. 1 for purposes of simplicity of the drawing), update blocking rules, and send the updated blocking rules back to each and every tracing agent and network. Application server includes application 152, which may generate, modify, and distribute blocking rules, detect sensitive information, and other functions. Application 152 is discussed in more detail with respect to FIG. 3.

FIG. 2 is a block diagram of a tracing agent. The block diagram of FIG. 2 provides more detail for each of the tracing agents within the system of FIG. 1. Tracing agent 200 of FIG. 2 includes traffic parsing module 210, user session identification module 220, alert generation module 230, rules engine 240, user model engine 250, compliance engine 260, and data exfiltration engine 270.

Traffic parsing module 210 may retrieve API requests and API responses, and parse the request and responses to extract data. The extracted data may be stored locally or sent to application 152 on application server 150. Traffic parsing module 210 intercepts live traffic, and does not generate copies of the traffic sent between micro-services. In some instances, tracing agent 200 may bucket similar API response data and may bucket similar API request data. API request and response pairs and send statistics and metrics of the bucket of data to application 152.

User session identification module 220 may identify user sessions based on the intercepted API requests an API response data. User session may include multiple user requests from one or more APIs, within some period of time. For example, a user session may begin when a user logs into an e-commerce website from a mobile device, browses the website for products for a few minutes from one location at home, and then makes a purchase the next day from their mobile device while at work, all while still logged in on their mobile device. Hence, a user session may span over several APIs, from one or more geological locations, over one or more days. More details for identify new user session are discussed in U.S. patent application Ser. No. 17/339,951, titled “Automatic Anomaly Detection Based on User Sessions,”, filed on Jun. 5, 2021.

Alert generation module 230 may be triggered to generate an alert, set flags, and generate and transmit notifications to a user, administrator, customer, or some other party. Examples of alerts or flags that may be used to set include detecting a privacy compliance violation, detecting a non-authorized user that has logged into a different users account, and other alerts.

Rules engine 240 may create, edit, manage, and transmit blocking rules to application 152 as well as one or more tracing agents. The blocking rules may indicate what part of a request should be blocked, were part of a response should be blocked, under what conditions should a request or response be blocked for user data privacy, suspicious or entrusted APIs, and user, customer, or administrator generated rules for blocking data or preventing transmission to particular APIs. In some instances, a tracing agent may create or modify a blocking rule locally, transmit the new or modified blocking rule to application 152, and application 152 may transmit the new or modified blocking rule to the remainder of the tracing agents in the system.

User model engine 250 may generate a user model. The user model may be used to keep a record of typical user API usage, access, and similar users. User model engine 250 may generate, edit, manage, and transmit a user model for users that access network system 103.

Compliance engine 260 may manage compliance rules that network system 103 must follow. Compliance engine 260 may also check a particular user model, or network system 103 as a whole, to determine if the system is in compliance based on API request and response data that is intercepted by the tracing agents.

Data exfiltration engine 270 may monitor user accounts to determine whether a particular user account has likely been accessed by an unauthorized user. Data exfiltration engine 270 may analyze user data based on intercepted API request and response data, and determine—based on the analyzed user data—whether the current user is authorized to access the account.

Though specific modules and engines are described in FIG. 2, it is not intended to be limiting. A tracing agent can have more or fewer modules/engines than that illustrated in FIG. 2, and the illustrated modules/engines can be combined or split apart into fewer modules. The modules listed are one example of how the functionality of a tracing agent can be organized, and other module configurations are possible and within the scope of the present technology to implement the functionality described herein.

FIG. 3 is a block diagram of an application. Application 300 of FIG. 3 provides more detail for application 152 of the system of FIG. 1. Application 300 includes traffic parsing 310, user session identification 320, alert generation 330, rules engine 340, user model engine 350, compliance engine 360, and data exfiltration engine 370. The modules of application 300 may function similarly to the modules of tracing agent 200 of FIG. 2, but may be implemented in a central location rather than a local to a micro service.

Though specific modules and engines are described in FIG. 3, it is not intended to be limiting. The application can have more or fewer modules/engines than that illustrated in FIG. 3, and the illustrated modules/engines can be combined or split apart into fewer modules. The modules listed are one example of how the functionality of an application can be organized, and other module configurations are possible and within the scope of the present technology to implement the functionality described herein.

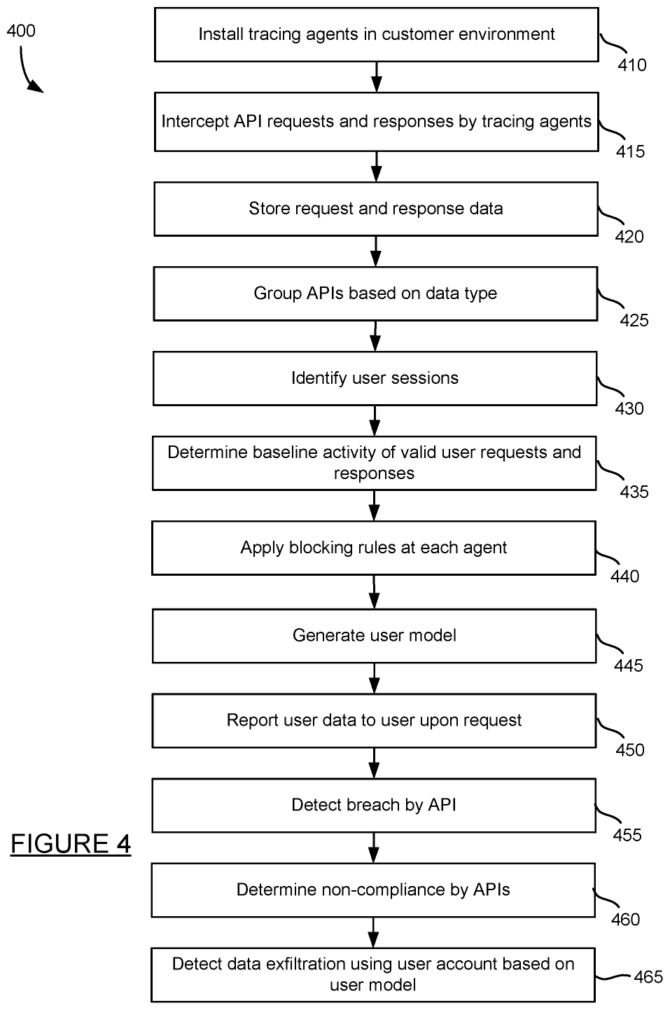

FIG. 4 is a method for intelligently tracing sensitive data flow. Tracing agents may be installed in a customer environment at step 410. In some instances, the customer environment may be implemented on one or more network based web service frameworks, such as Microsoft AZURE, Amazon AWS, Google Cloud Platform, IBM Cloud, or other web service platform. The testing agents of the present technology may be implemented in each of these platforms, as well as other frameworks, so that a network system 100 implemented in different frameworks may be completely monitored with tracing agents.

API request and API responses may be intercepted by tracing agents at step 415. Intercepting API requests and responses may include tracing agent code inserted within the micro service to generate a copy of an incoming API request and store a copy of an outgoing API response before the request is processed and/or before the response is transmitted.

The request data and response data may be stored at step 420. The request and response data may be stored locally at the tracing agent on the particular micro-service, transmitted to application 152 to be stored on application server 150 or at some other location by application 152, or stored in part or completely at both the intercepting tracing agent and application server 150.

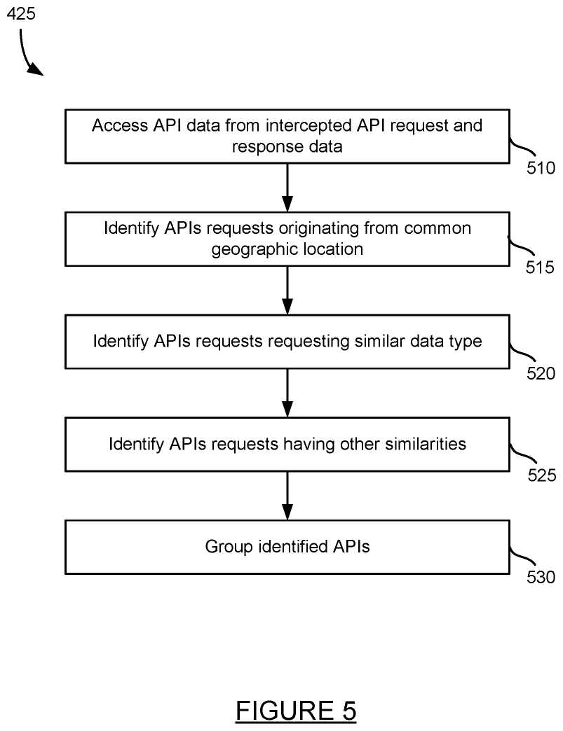

APIs may be grouped based on data type at step 425. Grouping APIs based on data type may include identifying API request and response geographic data, identifying datatypes, and other API similarities. More detail for grouping APIs based on data type is discussed with respect to the method of FIG. 5.

User sessions are identified at step 430. A user session may be a plurality of tasks or operations performed by a user to achieve an overall transaction. For example, a user session may involve a plurality of actions performed by the user while logged into an e-commerce site while purchasing a product. The tasks may include searching for products, adding one or more products to a cart, and performing checkout. User sessions can be identified based on data associated with a user identifier, APIs being accessed, and other request and response data.

A baseline activity is determined for valid user requests and responses at step 435. To determine baseline activity, user requests and responses are monitored for a period of time. The time period is long enough to identify typical patterns for typical transactions performed by a user. Determining baseline activity may take 10 minutes, an hour, eight hours, or one or more days. The baseline activity may indicate the typical geolocation from which a user accesses a network system 103, typical APIs accessed, the sequence in which APIs are accessed, and other user behavior that follows a pattern related to the APIs accessed by the user.

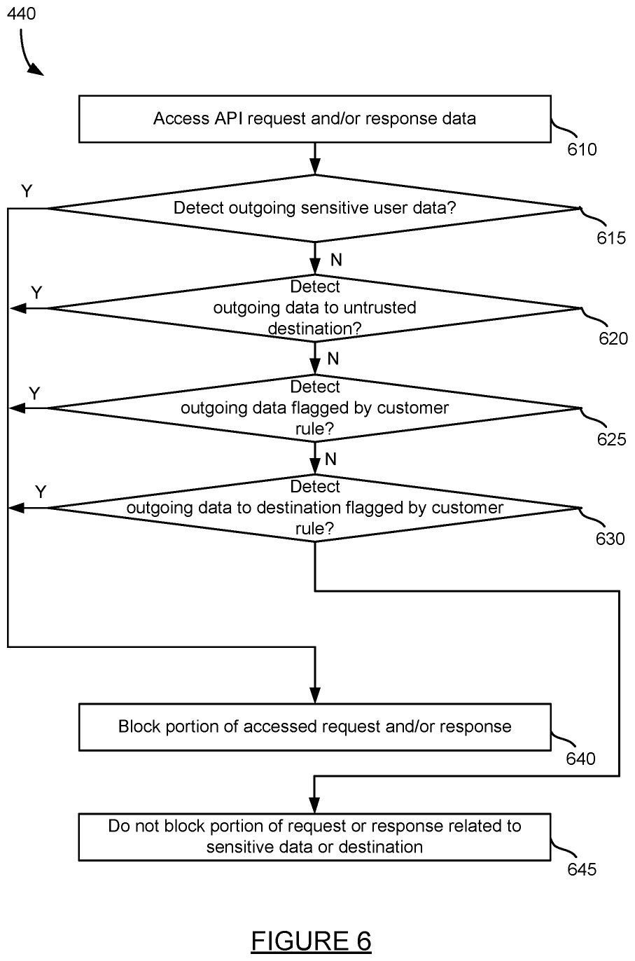

Blocking rules may be applied at each tracing agent at step 440. The blocking rules may be related to sensitive data, untrusted APIs, or user, administrator, or customer generated rules that should be applied to API request and response traffic. More details for applying blocking rules at and/or by a tracing agent is discussed with respect to the method of FIG. 6.

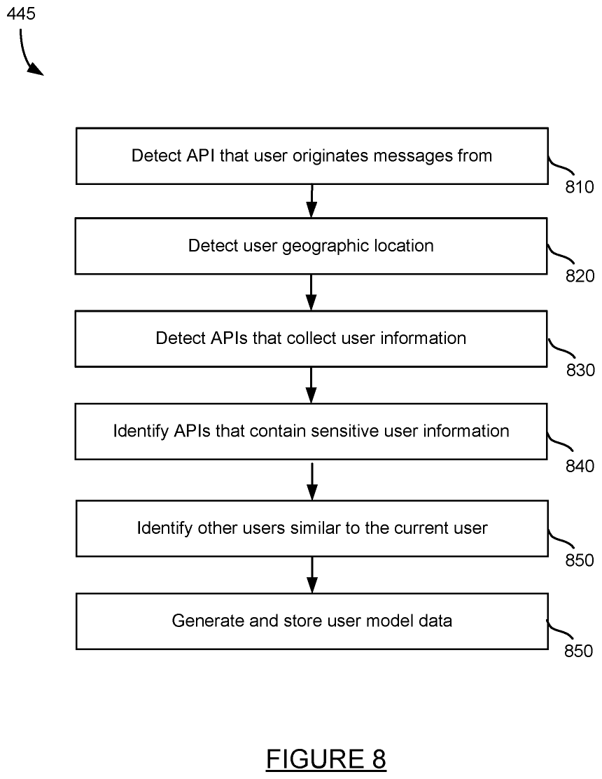

A user model is generated at step 445. A user model may include baseline and other data associated with user activity within network service 103. Generating a user model is discussed in more detail below with respect to the method of FIG. 8.

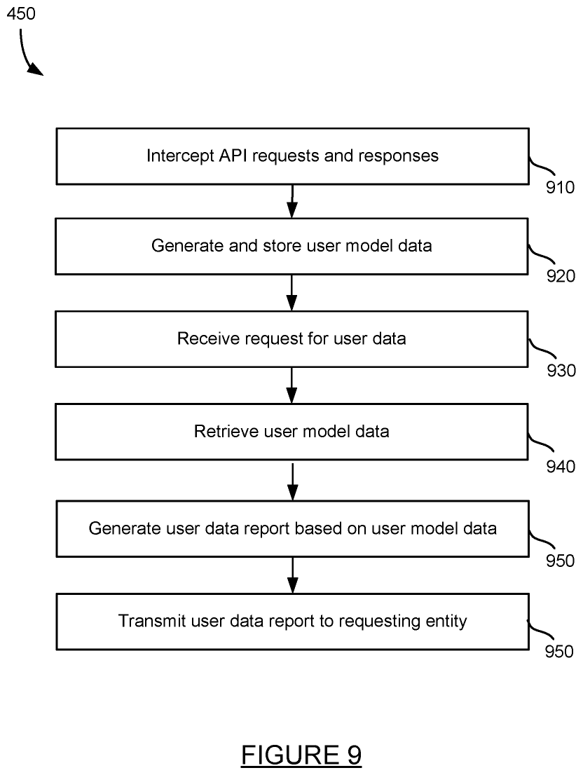

User data may be reported to a user or other authorized and requesting entity at step 450. In some jurisdictions, web-based service providers are required to report the data they collect for a user upon user request. The present system may quickly determine the data collected for a user and provide that data to the user, based on the request and response data obtained by tracing agents on an ongoing basis. Reporting user data to a user or other authorized entity upon request is discussed in more detail with respect to the method of FIG. 9.

A breach by an API is detected at step 455. Based on the baseline and typical user model, tracing agents and/or application 152 may generate blocking rules for blocking a request from untrusted APIs or other requests from APIs seeking to access sensitive user data. The breach may be detected at each and every tracing agent at each of the micro-services within a network service 103, not just the entry point and exit point of the overall network service 103. In some instances, the breach may be detected by applying the blocking rules and detecting that a portion of an API request needs to be blocked.

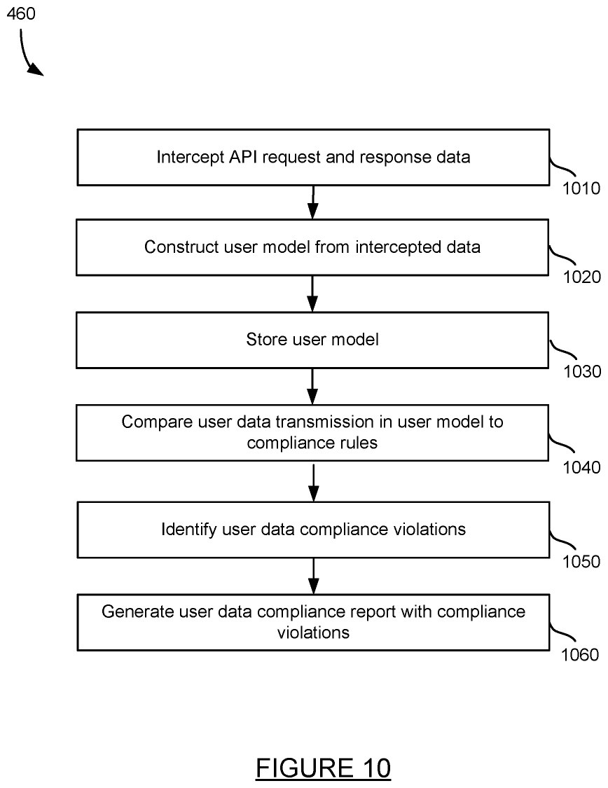

Noncompliance by APIs is determined at step 460. The noncompliance may be detected in real time by one or more tracing agents, or when requests and responses are analyzed at a later time by application 152. Determining noncompliance by one or more APIs is discussed in more detail with respect to the method of FIG. 10.

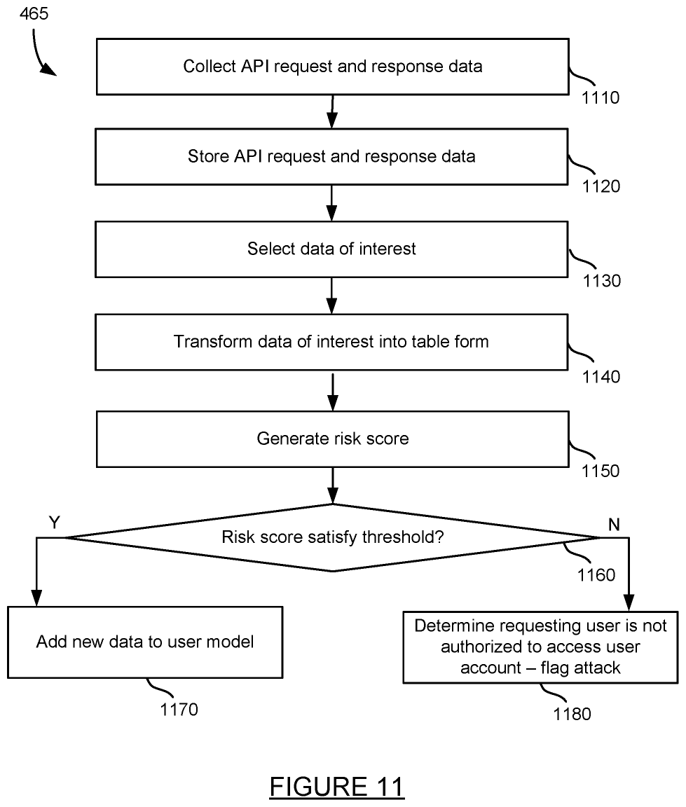

Data exfiltration is detected using the user account based on a user model at step 465. Data exfiltration of a user account may be detected by analyzing user activity that has infiltrated the account as compared to user activity for a user known to be authorized to access the user account. Detecting data exfiltration for a user account based on a user model is discussed in more detail below with respect to the method of FIG. 11.

FIG. 5 is a method for grouping APIs based on data type. The method of FIG. 5 provides more detail for step 425 of the method of FIG. 4. First, API data is accessed from the intercepted API requests and response data at step 510. The intercepted API requests and responses are intercepted at step 415 of the method of FIG. 4. API requests are identified which originate from a common geographic location at step 515. The geographic location may be a country, a set of servers, or some other geographic location.

API requests are identified which request similar datatypes at step 520. The present system may have a database having a large number of datatypes identified to be user sensitive data, for example credit card numbers, Social Security number, address data, phone number data, bank account data, and other types of data commonly considered sensitive data.

API requests having other similarities are identified at step 525. Other similarities may include users operating from a similar location, users belonging to the same organization, such as having the same auto insurance, and other similarities. APIs are grouped at step 530. APIs may be grouped based on having one or more similarities, such as originating from a common location, having a similar datatype, or some other similarity. In some instances, the grouping can be performed based on aspects of compliance requirements.

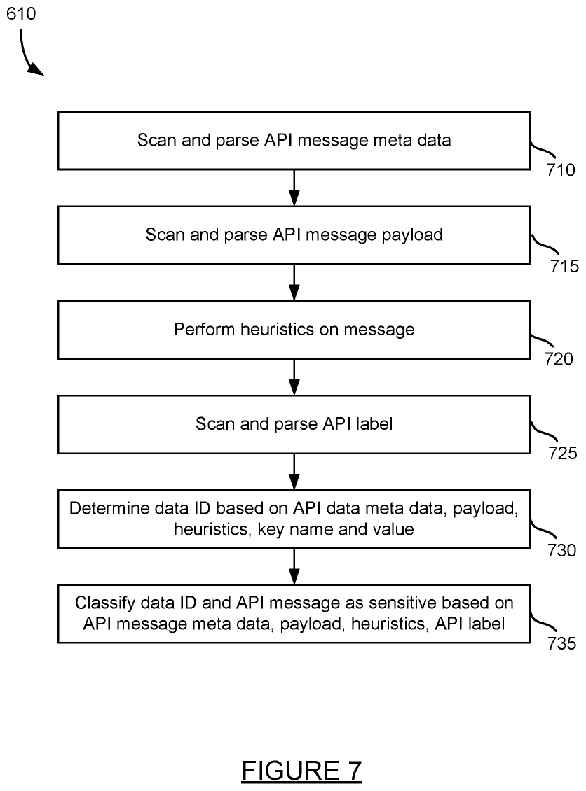

FIG. 6 is a method for applying blocking rules at an agent. The method of FIG. 6 provides more detail for step 440 of the method of FIG. 4. API requests and/or responses are accessed at step 610. Accessing API requests and/or responses are discussed in more detail below with respect to the method of FIG. 7. A determination is then made as to whether a request or response includes outgoing sensitive user data at step 615. If it is detected that an outgoing request or response includes data identified as sensitive user data, the method of FIG. 6 continues to step 640.

If there is no outgoing sensitive user data detected, a determination is made at step 620 as to whether outgoing data is detected to be transmitted (or about to be transmitted) to an untrusted destination. A trusted destination may include a blacklisted API address. In some instances, untrusted destination may include a shadow API that touches sensitive data, an orphan API that is unused, or some other improperly managed or improperly secured API. If an outgoing request or response is detected to be transmitted to an un-trusted destination, the method of FIG. 6 continues to step 640.

If data is not going to an untrusted destination, a determination is made as to whether the outgoing data is flagged by a customer rule to not be transmitted at step 625. In some instances, in addition to typical compliance rules, a customer that manages network system 103 may specify or identify user or other data which should not be transmitted a request or response. If the data specified by customer rules is detected to be transmitted in a request or response at step 625, the method of FIG. 6 continues to step 640. If no data flagged by customers is detected in the outgoing transmission, a determination is made as to whether outgoing data is detected to be transmitted to a destination flagged by a customer rule at step 630. In some instances, a customer that manages network 103 may identify destinations, such as particular API addresses, to which no sensitive data should be transmitted. If outgoing data is detected to be transmitted to a customer flagged destination, the method of FIG. 6 continues to step 640. If no outgoing data is detected to be transmitted to a flagged destination, then the blocking rules did not detect any sensitive data or un-trusted destination, or any data or location flagged by the customer, and no portion of the access request or response needs to be blocked at step 645.

At step 640, at least a portion of a request or response is blocked. Blocking a portion of a response may include modifying a portion of the response. The modification can include, for example, replacing sensitive user data with a token, hash, or other value. In some instances, modification includes suppressing the sensitive user data by scrambling the data or removing the data. The blocked portion of the access request and/or response may include sensitive user data, and an untrusted destination, data flagged by a customer rule, or a destination flagged by a customer rule. The portion may include just the detected or flagged data, or the entire request or response. In any case, the blocked portion may be suppressed, replaced with a label or a hash, or otherwise removed from the access request or response.

FIG. 7 is a method for accessing an API data request and/or response. The method of FIG. 7 provides more detail for step 610 of the method of FIG. 6. An API message is scanned and parsed to detect metadata at step 710. The metadata may be located at different portions of the API message, namely the API request or response. Metadata is scanned and parsed to identify information related to sensitive information, such as address information, credit card information, phone number information, bank account information, or other sensitive information. An API message payload may be scanned and parsed at step 715. The payload may be scanned and parsed to detect sensitive information that might be contained in the payload.

Heuristics may be performed on the message at step 720. FIG. 6 may be performed to detect if the particular message is likely to contain sensitive information based on heuristic data associated with other messages having sensitive information. In some instances, the heuristics on the current message are compared to heuristics on other messages which contain sensitive information, and a comparison is performed to determine if the two heuristics match within a particular threshold, such as 10%, 20%, 30%, 40%, or some other threshold. An API label may then be scanned and parsed at step 725. The API label is scanned and parsed to identify metadata related to sensitive information, such as address information, credit card information, phone number information, bank account information, or other sensitive information.

A data identifier is determined based on the detected API data metadata, payload, heuristics, and a key name and value at step 730. The data ID and API message may be classified as sensitive based on the API message metadata, payload, heuristics, and API label at step 735. In some instances, if one or more of the meta data, payload, heuristics, API label, or key name and value suggest that the API message may include sensitive information, then the message ID is flagged as including sensitive information. The analyzed message and other messages with a similar ID can subsequently be treated as including sensitive information.

FIG. 8 is a method for detecting a breach by an API. Method of FIG. 8 provides more detail for step 445 of the method of FIG. 5. And APIs detected that the user messages originate from at step 810. This may be an API that the user request typically originate from, for example for at least a majority of recognized user login attempts. A user geographic location can be detected at step 820. The user geographic location can be a city, ZIP Code, a state or region of a country, or a country. APIs that collect user information are detected at step 830. APIs that collect user information may collect them over minutes, days, or even weeks. APIs that contain sensitive user information, or request to respond with sensitive user information, are identified at step 840. These are APIs that may expose user privacy. Other users similar to the current user are identified at step 850. As changes or conditions are detected associated with the current user or one of the similar users, the other similar users can be treated similarly or can be examined to check for compliance. The detected and identified data for the user is stored as a user model at step 850.

FIG. 9 is a method for reporting user data to a user upon request. The method of FIG. 9 provides more detail for step 450 of the method of FIG. 4. API requests and responses are intercepted at step 910. Intercepting API request and responses can occur at step 415 of FIG. 4, and are performed continuously as traffic occurs. A user model is generated and stored at step 920. The user model is generated and stored as discussed with respect to the method of FIG. 8. A request for user data may be received at step 930. Regulations often require that web service providers provide a copy of the collected data for the user upon the user's request. If such a request is received at step 930, the data associated with the user model is retrieved at step 940. A user data report may be generated based on the user model data at step 950. The user data report may be transmitted to the requesting user or other entity at step 950.

FIG. 10 is a method for determining noncompliance by an API. The method of FIG. 10 provides more detail for step 460. API request and response data may be intercepted at step 1010. This may be performed continuously, as discussed with respect to step 415 of the method of FIG. 4. A user model may be constructed from the intercepted data at step 1020. The user model may be generated as discussed with respect to the method of FIG. 8. User model data stored at step 1030.

A comparison of the transmission of user data as indicated in the user model against the compliance rules is performed at step 1040. The comparison determines if the data transmitted from the user complies with current compliance regulations. User data compliance for violations is identified at step 1050. A compliance violation occurs if sensitive user data is transmitted to an API address that is not secure or otherwise does not comply with compliance rules. A user data compliance report is generated with the compliance violations at step 1060.

FIG. 11 is a method for detecting data exfiltration using a user account based on a user model. The method of FIG. 11 provides more detail for step 465 of the method of FIG. 4. API request and response data is collected at step 1110. Collecting API request and response data is performed continuously by intercepting API requests and responses, as discussed with respect to step 415 of the method of FIG. 4. API request and response data is stored at step 1120.

Data of interest is selected at step 1130. The data of interest may be picked from the request and response data, and may include data that aligns with or is in the same category as data in a user model. The selected data may be transformed into table form and stored at step 1140.

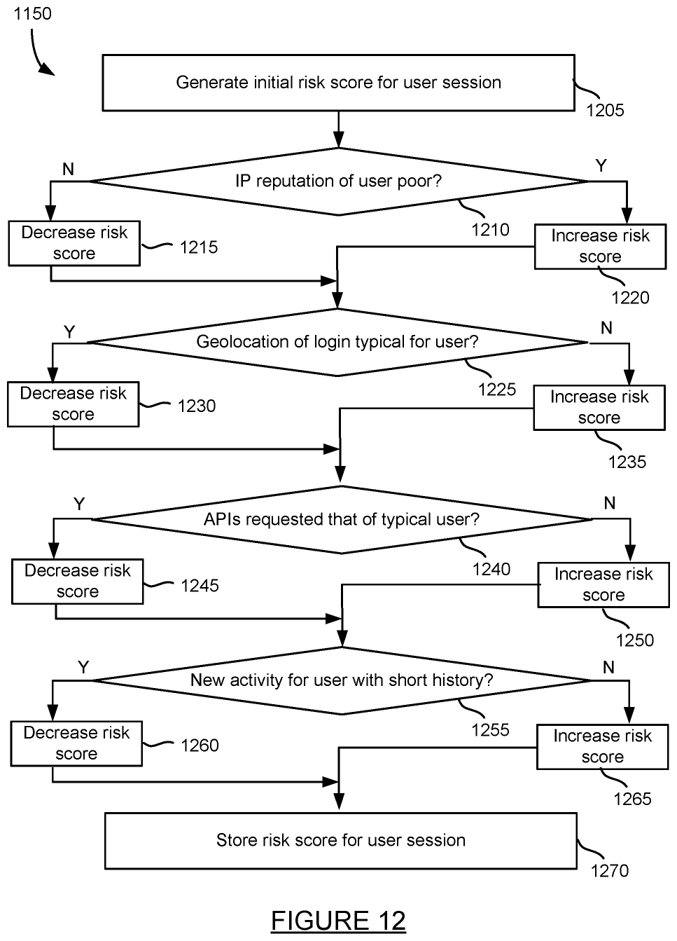

A risk score is generated for the user session at step 1150. A risk score may indicate the likelihood that the current user with access to a user account is not an authorized user. Generating a risk score is discussed in more detail with respect to the method of FIG. 12. A determination is made as to whether the risk score satisfies a threshold at step 1160. For example, the risk score may be a prediction as to whether the user with access to an account is an authorized user for that account. If the risk threshold is 50%, and the risk score is below 50%, then the risk score threshold is not satisfied and is determined that the requesting user is not authorized to be logged in to the user account at step 1180. An attack me there for be flagged at step 1180. If the risk score threshold is 50%, and the generated risk score is 80%, that it may be determined that the logged in user is an authorized user and the new data for the user may be added to the user model at step 1170. The new data may include a new location from which the user logs in, a new sequence of APIs used by the user, or other data.

FIG. 12 is a method for generating a risk score. The method of FIG. 12 provides more detail for step 1150 of the method of FIG. 11. An initial risk score is generated for the current user session at step 1205. In some instances, the initial risk score may be 50, five, or some other number between a range for the risk score. A determination is made as to whether the IP reputation of the current logged in user is poor at step 1210. An IP reputation may be poor if the IP addresses of the current user from which a request is generated is known to be associated with unauthorized users. If the IP reputation of the user is poor, the risk score is increased at step 1220 and the method continues to step 1225. If the IP reputation of the user is not poor, the risk score is decreased at step 1215 and the method continues to step 1225. In some instances, for each of decisions 1210, 1225, 1240 and 1255, the risk score may be increased or decreased, accordingly, by a percentage, a particular weight, or some other amount.

A determination is made as whether the geolocation of the current login is typical for the user at step 1225. A determination of the typical login may be determined from the user model, stored API request and response data associated with a particular user, or other data. If the geolocation is typical, the risk score may be decreased at step 1230, and the method continues to step 1240. If the geolocation of the login is not typical for the user, the risk score is increased at step 1235, and the method continues to step 1240.

A determination is made as to whether the requested APIs are typical of the user associated with the current session at step 1240. A determination as to whether the typical APIs are requested may be determined from the user model, stored API request and response data associated with a particular user, or other data. If the APIs requested are not typical, the risk score is increased at step 1250, and the method of FIG. 12 continues to step 1255. If the requested APIs are typical, the risk score is decreased at step 1245, and the method continues to step 1255.

A determination as to whether the new activity for the user is not known because of a user's short history at step 1255. If data for a particular user or account has only been collected for a short period of time, such as for example 10 minutes, 30 minutes, or 60 minutes, the recently detected requests by the user may not be in the user model. If new activity for the user is due to a short history being stored for the user, the risk score for the session is decreased at step 1260, and the method of FIG. 12 continues to step 1270. If there is a considerable amount of history for the user, for example more than a day or a few days, then the new activity for the user is not associated with a short history and the risk score is increased at step 1265. The method of FIG. 12 then continues to step 1270.

The risk score is stored for the user session at step 1270. This risk score is then utilized in the method of FIG. 11 to detect data exfiltration associated with the user account.

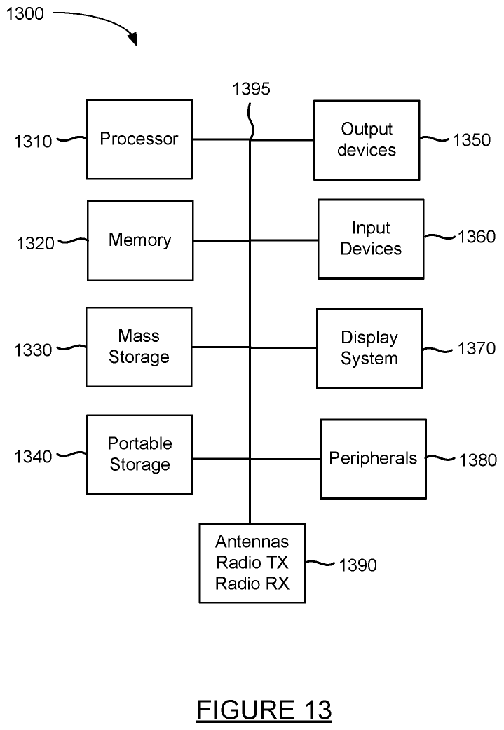

FIG. 13 is a block diagram of a computing environment for implementing the present technology. System 1300 of FIG. 13 may be implemented in the contexts of the likes of machines that implement client device 110, API gateway 120, microservices 121-126, data store 127, third party servers 140-143, and application server 150. The computing system 1300 of FIG. 13 includes one or more processors 1310 and memory 1320. Main memory 1320 stores, in part, instructions and data for execution by processor 1310. Main memory 1320 can store the executable code when in operation. The system 1300 of FIG. 13 further includes a mass storage device 1330, portable storage medium drive(s) 1340, output devices 1350, user input devices 1360, a graphics display 1370, and peripheral devices 1380.

The components shown in FIG. 13 are depicted as being connected via a single bus 1395. However, the components may be connected through one or more data transport means. For example, processor unit 1310 and main memory 1320 may be connected via a local microprocessor bus, and the mass storage device 1330, peripheral device(s) 1380, portable storage device 1340, and display system 1370 may be connected via one or more input/output (I/O) buses.

Mass storage device 1330, which may be implemented with a magnetic disk drive, an optical disk drive, a flash drive, or other device, is a non-volatile storage device for storing data and instructions for use by processor unit 1310. Mass storage device 1330 can store the system software for implementing embodiments of the present invention for purposes of loading that software into main memory 1320.

Portable storage device 1340 operates in conjunction with a portable non-volatile storage medium, such as a floppy disk, compact disk or Digital video disc, USB drive, memory card or stick, or other portable or removable memory, to input and output data and code to and from the computer system 1300 of FIG. 13. The system software for implementing embodiments of the present invention may be stored on such a portable medium and input to the computer system 1300 via the portable storage device 1340.

Input devices 1360 provide a portion of a user interface. Input devices 1360 may include an alpha-numeric keypad, such as a keyboard, for inputting alpha-numeric and other information, a pointing device such as a mouse, a trackball, stylus, cursor direction keys, microphone, touch-screen, accelerometer, and other input devices. Additionally, the system 1300 as shown in FIG. 13 includes output devices 1350. Examples of suitable output devices include speakers, printers, network interfaces, and monitors.

Display system 1370 may include a liquid crystal display (LCD) or other suitable display device. Display system 1370 receives textual and graphical information and processes the information for output to the display device. Display system 1370 may also receive input as a touch-screen.

Peripherals 1380 may include any type of computer support device to add additional functionality to the computer system. For example, peripheral device(s) 1380 may include a modem or a router, printer, and other device.

The system of 1300 may also include, in some implementations, antennas, radio transmitters and radio receivers 1390. The antennas and radios may be implemented in devices such as smart phones, tablets, and other devices that may communicate wirelessly. The one or more antennas may operate at one or more radio frequencies suitable to send and receive data over cellular networks, Wi-Fi networks, commercial device networks such as a Bluetooth device, and other radio frequency networks. The devices may include one or more radio transmitters and receivers for processing signals sent and received using the antennas.

The components contained in the computer system 1300 of FIG. 13 are those typically found in computer systems that may be suitable for use with embodiments of the present invention and are intended to represent a broad category of such computer components that are well known in the art. Thus, the computer system 1300 of FIG. 13 can be a personal computer, handheld computing device, smart phone, mobile computing device, tablet computer, workstation, server, minicomputer, mainframe computer, or any other computing device. The computer can also include different bus configurations, networked platforms, multi-processor platforms, etc. The computing device can be used to implement applications, virtual machines, computing nodes, and other computing units in different network computing platforms, including but not limited to AZURE by Microsoft Corporation, Google Cloud Platform (GCP) by Google Inc., AWS by Amazon Inc., IBM Cloud by IBM Inc., and other platforms, in different containers, virtual machines, and other software. Various operating systems can be used including UNIX, LINUX, WINDOWS, MACINTOSH OS, CHROME OS, IOS, ANDROID, as well as languages including Python, PHP, Java, Ruby, .NET, C, C++, Node.JS, SQL, and other suitable languages.

The foregoing detailed description of the technology herein has been presented for purposes of illustration and description. It is not intended to be exhaustive or to limit the technology to the precise form disclosed. Many modifications and variations are possible in light of the above teaching. The described embodiments were chosen to best explain the principles of the technology and its practical application to thereby enable others skilled in the art to best utilize the technology in various embodiments and with various modifications as are suited to the particular use contemplated. It is intended that the scope of the technology be defined by the claims appended hereto.

What is claimed is:

1. A method for tracing sensitive data flow, comprising:
intercepting API traffic between a client and a plurality of microservices, the API traffic including API requests and API responses associated with at least one user;
identifying API traffic that contains user data identified as sensitive user data at one of the plurality of microservices;
applying a blocking rule, at the one of the plurality of microservices, to the API traffic that contains user data identified as sensitive user data;
modifying a response to remove, based on the blocking rule, the identified sensitive user data from being included within the response to the identified API traffic; and
transmitting the modified response.

2. The method of claim 1, wherein intercepting API traffic is performed by a tracing agent installed at each of the plurality of microservices.

3. The method of claim 2, wherein the blocking rules are provided to each of the plurality of tracing agents by a remote application.

4. The method of claim 2, wherein the blocking rules are applied by the tracing agent at the one of the plurality of microservices.

5. The method of claim 1, wherein user data is identified as sensitive user data based on a predefined data type or by an administrator rule.

6. The method of claim 1, further comprising:
generating a user model based on the intercepted API traffic, the user model including user geographic information, user typical API requests, and user API baseline activity; and
determining non-compliance of user sensitive data flow based on the user model and data compliance rules.

7. The method of claim 1, further comprising:
generating a user model based on the intercepted API traffic, the user model including user geographic information, user typical API requests, and user API baseline activity; and
determining that a current user session is a breach of a user account based on the user model and intercepted API request and API response data.

8. A non-transitory computer readable storage medium having embodied thereon a program, the program being executable by a processor to perform a method for tracing sensitive data flow, the method comprising:
intercepting API traffic between a client and a plurality of microservices, the API traffic including API requests and API responses associated with at least one user;
identifying API traffic that contains user data identified as sensitive user data at one of the plurality of microservices;
applying a blocking rule, at the one of the plurality of microservices, to the API traffic that contains user data identified as sensitive user data;
modifying a response to remove, based on the blocking rule, the identified sensitive user data from being included within the response to the identified API traffic; and
transmitting the modified response.

9. The non-transitory computer readable storage medium of claim 8, wherein intercepting API traffic is performed by a tracing agent installed at each of the plurality of microservices.

10. The non-transitory computer readable storage medium of claim 9, wherein the blocking rules are provided to each of the plurality of tracing agents by a remote application.

11. The non-transitory computer readable storage medium of claim 9, wherein the blocking rules are applied by the tracing agent at the one of the plurality of microservices.

12. The non-transitory computer readable storage medium of claim 8, wherein user data is identified as sensitive user data based on a predefined data type or by an administrator rule.

13. The non-transitory computer readable storage medium of claim 8, the method further comprising:
generating a user model based on the intercepted API traffic, the user model including user geographic information, user typical API requests, and user API baseline activity; and
determining non-compliance of user sensitive data flow based on the user model and data compliance rules.

14. The non-transitory computer readable storage medium of claim 8, the method further comprising:
generating a user model based on the intercepted API traffic, the user model including user geographic information, user typical API requests, and user API baseline activity; and
determining that a current user session is a breach of a user account based on the user model and intercepted API request and API response data.

15. A system for tracing sensitive data flow, comprising:
one or more servers, wherein each server includes a memory and a processor; and
one or more modules stored in the memory and executed by at least one of the one or more processors to intercept API traffic between a client and a plurality of microservices, the API traffic including API requests and API responses associated with at least one user, identify API traffic that contains user data identified as sensitive user data at one of the plurality of microservices, apply a blocking rule, at the one of the plurality of microservices, to the API traffic that contains user data identified as sensitive user data, modify a response to remove, based on the blocking rule, the identified sensitive user data from being included within the response to the identified API traffic, and transmitting the modified response.

16. The system of claim 15, wherein intercepting API traffic is performed by a tracing agent installed at each of the plurality of microservices.

17. The system of claim 16, wherein the blocking rules are provided to each of the plurality of tracing agents by a remote application.

18. The system of claim 16, wherein the blocking rules are applied by the tracing agent at the one of the plurality of microservices.

19. The system of claim 15, wherein user data is identified as sensitive user data based on a predefined data type or by an administrator rule.

20. The system of claim 15, the one or more modules further executable to generate a user model based on the intercepted API traffic, the user model including user geographic information, user typical API requests, and user API baseline activity, and determine non-compliance of user sensitive data flow based on the user model and data compliance rules.

21. The system of claim 15, the one or more modules further executable to generate a user model based on the intercepted API traffic, the user model including user geographic information, user typical API requests, and user API baseline activity, and determine that a current user session is a breach of a user account based on the user model and intercepted API request and API response data.
